(19) United States
(12) Patent Application Publication
(10) Pub. No.: US 2017/0326915 A1
(43) Pub. Date: Nov. 16, 2017

(54) NON-PNEUMATIC TIRE

(71) Applicants: Young ll SON, Seoul (KR); Thomas Hongchul Son, Seoul (KR)

(72) Inventors: Young Il SON, Seoul (KR); Thomas Hongchul SON, Seoul (KR)

(73) Assignees: Young Il SON, Seoul (KR); Thomas Hongchul SON, Seoul (KR); YOUIIL INDUSTRIES CORPORATION, Jeollanam-do (KR)

(21) Appl. No.: 15/525,588

(22) PCT Filed: Oct. 28, 2015
(86) PCT No.: PCT/KR2015/011434

§ 371 Date: May 10, 2017

(30) Foreign Application Priority Data
Nov. 11, 2014 (KR) 10-2014-0156325

(51) Int. Cl. B60C 7/10; B60C 7/24

(52) U.S. Cl. CPC B60C 7/10; B60C 7/24

(57) ABSTRACT

A non-pneumatic tire compries a tire wheel; a rim which is made of a rigid material and concentrically disposed at an interval with respect to the tire wheel; spokes each of which has one side fastened to a circumference of the tire wheel and the other side fastened to a circumference of the rim and elastically supports the interval between the tire wheel and the rim; and a tire cover which is coupled to cover the rim and has a tread pattern formed on an outer surface of the tire cover, wherein the rim has a plurality of circular rings having a width and a thickness, the plurality of rings is disposed to face one another at intervals in a width direction of the tire cover, and interval support members, which elastically support the intervals among the rings and bind the rings, are provided among the rings.

### CROSS REFERENCE TO PRIOR APPLICATIONS

This application is a National Stage Application of PCT International Patent Application No. PCT/KR2015/011434 filed on Oct. 28, 2015, under 35 U.S.C. §371, which claims priority to Korean Patent Application No. 10-2014-0156325 filed on Nov. 11, 2014, which are all hereby incorporated by reference in their entirety.

### BACKGROUND

The present invention relates to a non-pneumatic tire capable of withstanding external force to minimize deformation, maintaining an inherent shape of the tire, and thus stably maintaining traveling performance, velocity, and ride quality.

In general, in the case of a pneumatic tire, there is inconvenience of having to frequently inspect air pressure that is absolutely important in exhibiting performance, and there is a risk of an accident when the pneumatic tire is pricked by an external object or damaged due to impact while a vehicle travels.

Recently, to eliminate the aforementioned inconvenience and risk, a non-pneumatic tire is disclosed in Korean Patent Nos. 10-1053915 and 10-1301578 and the like.

The introduced non-pneumatic tire in the related art encounters a limitation of a material that may withstand expansion and contraction caused by repeated impact when the vehicle travels in a state in which a weight of the vehicle is applied.

In addition, unlike the pneumatic tire, since the non-pneumatic tire in the related art is limited in respect to a range in which impact is dispersed when the non-pneumatic tire collides with an obstacle while the vehicle travels on a road, the non-pneumatic tire is highly likely to be partially damaged, and the non-pneumatic tire is slowly restored to an original condition thereof, and as a result, there is a problem in that it is difficult to maintain a velocity as well as traveling performance when the vehicle travels at a high speed.

An object of the present invention is to provide a non-pneumatic tire which disperses external force, which occurs when the non-pneumatic tire collides with a locally protruding portion on a road surface, to a circumferential region of the non-pneumatic tire and reduces a dispersion of the external force in a width direction of the non-pneumatic tire, thereby elastically and stably maintaining an inherent circular shape of the non-pneumatic tire, ensuring a ground contact area with a ground surface, stably maintaining traveling performance and velocity, improving ride quality, and reducing a risk of an accident.

### SUMMARY

A characterized configuration of a non-pneumatic tire according to the present invention includes: a tire wheel; a rim which is made of a rigid material and concentrically disposed at an interval with respect to the tire wheel; spokes each of which has one side fastened to a circumference of the tire wheel and the other side fastened to a circumference of the rim and elastically supports the interval between the tire wheel and the rim; and a tire cover which is coupled to cover an outer surface of the rim and has a tread pattern formed on an outer surface of the tire cover, in which the rim has a plurality of circular rings having a width and a thickness, the plurality of rings is disposed to face one another at intervals in a width direction of the tire cover, and interval support members, which elastically support the intervals among the rings in a staggered direction and bind the rings, are provided among the rings.

In addition, belts, which have tensile force in a radial direction, a circumferential direction, and a diagonal direction and cover a circumference of the rim, may be bound at an inner circumferential edge and/or an outer circumferential edge of the rim.

Further, each of the rings may have fastening holes which penetrate a surface of the ring in a thickness direction of the ring, and the rings may be connected by binding members which are made of an elastic material and fastened to the fastening holes by penetrating the fastening holes from the arrangement of the rings.

Further, the tire cover may be formed by connecting the rim, the belts disposed at the inner circumferential edge and/or the outer circumferential edge of the rim, and the binding members, mounting the rim, the belts, and the binding members into a mold, injecting molten resin into the mold so that spaces among the components are filled with the molten resin, and integrally covering exteriors of the components, and the interval support member may be a part of the tire cover with which the space among the rings is filled during a process of forming the tire cover.

Therefore, the ring may have a plurality of first fastening portions which protrude from an inner side of the tire cover along an inner circumferential edge of the ring, the tire wheel may have second fastening portions which correspond to the first fastening portions along a circumference of the tire wheel, and the spoke may connect the first and second fastening portions.

In addition, the spoke may include a first spoke which is installed in an extended state between the first and second fastening portions and provides elastic force in a direction in which the interval between the first and second fastening portions is decreased, and a second spoke which is installed in a compressed state between the first and second fastening portions and provides elastic force in a direction in which the interval between the first and second fastening portions is increased.

Further, the second spoke may have a block shape which is made of an elastic rubber material and has a through hole corresponding to the interval between the first and second fastening portions, and may be installed by having a size corresponding, in a one-to-one manner, to the interval between the first and second fastening portions or by being fitted into the interval in an interference-fit manner, and the first spoke may have a band shape, and may have one end that is connected to the first fastening portion, and the other end that penetrates the through hole and the wheel corresponding to the through hole so as to be connected to the second fastening portion inside the wheel.

Meanwhile, the tire cover may include a cover body which integrally binds the rim, the belts disposed at the inner circumferential edge and/or the outer circumferential edge of the rim, and the binding member, and a tread portion which covers an outer circumferential edge of the cover body, has a tread formed on an outer circumferential surface of the tread portion, and has both edge portions in the radial direction which elastically surround and cover a part of an inner circumferential edge of the cover body.

Further, the spoke, which is installed at an intermediate portion in a width direction of the rim, may have higher elastic force than the spokes installed at both sides in the width direction of the rim.

According to the present invention, the rim made of a rigid material is formed by arranging the plurality of rings in the width direction of the tire, such that a ground contact surface in the width direction of the tire is ensured, and physical force applied to the tire is uniformly distributed to the entire tire, and further, the respective spokes, which connect the rings to the wheel, are configured such that elastic force applied to edge potions at both sides in the width direction of the tire and elastic force applied to an intermediate portion in the width direction of the tire are different from each other, such that a collision with a locally protruding obstacle such as a stone on the road is efficiently dispersed, ride quality is improved, traveling performance and velocity are stably maintained, and a risk of an accident is reduced.

### BRIEF DESCRIPTION OF THE DRAWINGS

FIG. 1 is a perspective view schematically illustrating a binding relationship between components and a rim of a non-pneumatic tire according to an exemplary embodiment of the present invention.

FIG. 2 is a partial cross-sectional view illustrating an exemplary embodiment in a state in which the rim illustrated in FIG. 1 is installed.

FIG. 3A and 3B are partial cross-sectional views illustrating an example in which spokes, which connect the rim illustrated in FIG. 1 with a wheel, is installed.

FIG. 4 is a cross-sectional view, when viewed from the front side, for explaining components of the non-pneumatic tire and a connection relationship among the components according to the exemplary embodiment of the present invention.

FIG. 5 is a cross-sectional view schematically illustrating a state in which force is absorbed with respect to an obstacle protruding from a road according to the exemplary embodiment of the present invention.

### DETAILED DESCRIPTION

A best mode of a non-pneumatic tire according to the present invention includes: a tire wheel; a rim which is made of a rigid material and concentrically disposed at an interval with respect to the tire wheel; spokes each of which has one side fastened to a circumference of the tire wheel and the other side fastened to a circumference of the rim and elastically supports the interval between the tire wheel and the rim; and a tire cover which is coupled to cover an outer surface of the rim and has a tread pattern formed on an outer surface of the tire cover, in which the rim has a plurality of circular rings having a width and a thickness, the plurality of rings is disposed to face one another at intervals in a width direction of the tire cover, and interval support members, which elastically support the intervals among the rings in a staggered direction and bind the rings, are provided among the rings.

A non-pneumatic tire according to the present invention includes a tire wheel W, a rim 10 which is made of a rigid material and concentrically disposed at an interval with respect to the tire wheel W, spokes 30 and 400 each of which has one side fastened to a circumference of the tire wheel W and the other side fastened to an inner circumference of the rim 10 and elastically supports the interval between the tire wheel W and the rim 10, and a tire cover 20 which is coupled to cover an outer surface of the rim 10 and has a tread pattern formed on an outer surface of the tire cover.

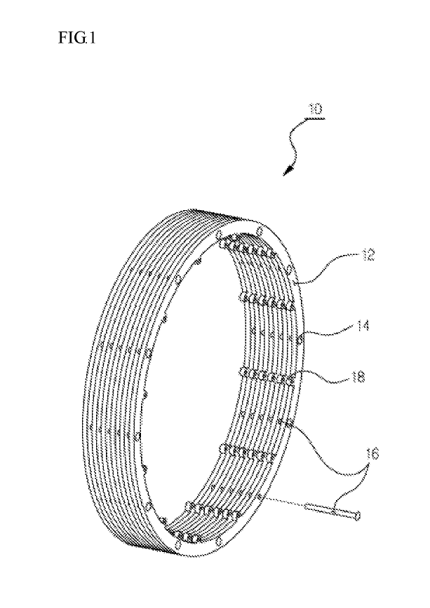

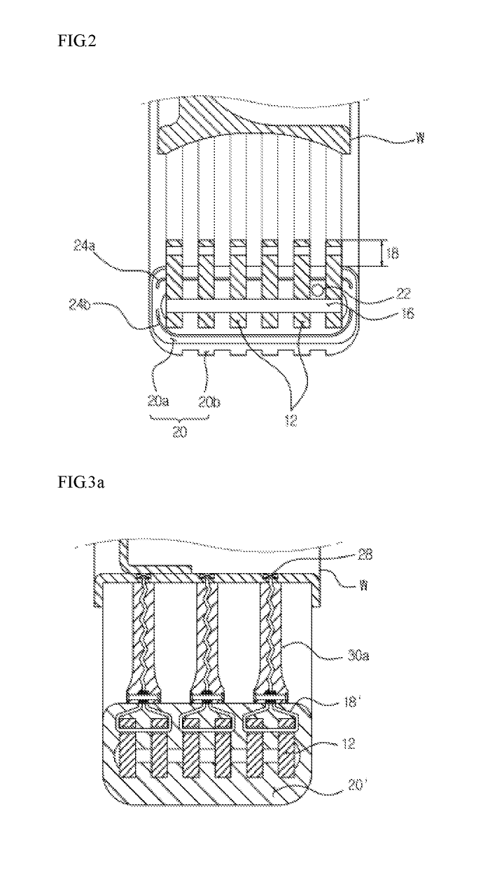

In addition, among the components of the present invention, as illustrated in FIGS. 1 and 2, the rim 10 has a plurality of circular rings 12 having a width and a thickness, the plurality of rings 12 is disposed to face one another at intervals in a width direction of the tire cover 20, and interval support members 22, which elastically support the intervals among the rings 12 in a staggered direction and bind the rings 12, are provided among the rings 12.

Further, as illustrated in FIG. 5, the interval support members 22 may be made of a material having tensile force and elastic force in order to enable the arrangement of the rings 12 to be staggered when some of the arranged rings 12 collide with an obstacle O such as a stone on the road, and maintain an attached state with the rings 12 so that the rings 12 are not spread in a width direction of the tire.

In addition, the interval support members 22 are configured to adjust a degree to which a part of the tire cover 20, with which the spaces between the rings 12 are filled and charged during a process of manufacturing the tire cover 20 to be described below, is staggered with respect to the interval between the rings 12.

Further, as illustrated in FIG. 1, each of the rings 12 has a plurality of fastening holes 14 which is disposed at an equal interval along a surface of the ring 12 and penetrates the ring 12 in a thickness direction of the ring 12, and binding members 16, which are made of an elastic material and penetrate the fastening holes 14, respectively, from the arrangement of the rings 12, and are fixedly fastened to the ring 12 positioned at one side end and the ring 12 positioned at the other side end, are connected to the fastening holes 14.

The binding member 16 may be a metal wire having high elasticity or a synthetic resin wire having high tensile force so as to be elastically deformable when the rings 12 are staggered, and to support the interval support members 22 and the interval between one side ring 12 and the other side ring 12.

Further, the ring 12 may have first fastening portions 18 which protrude inward at an inner circumferential edge of the ring 12.

As illustrated in FIG. 1, the first fastening portion 18 is illustrated in a loop shape extending and protruding inward from the inner circumferential edge of the ring 12, but the present invention is not limited thereto, and the first fastening portion 18 is to be fastened to one end of the spoke to be described below, and may of course be formed to have various types of fastening structures such as a threaded fastening structure or a socket structure to be fastened to one end of the spoke.

In addition, belts 24a and 24b, which have tensile force in a radial direction, a circumferential direction, and a diagonal direction, may be bound integrally with the rim 10 at an inner circumferential edge, an outer circumferential edge, or both of the inner circumferential edge and the outer circumferential edge of the rim 10 so as to cover a circumference of the rim 10.

Here, in a case in which the first fastening portions 18 are formed at the inner circumferential edge of the ring 12 that constitutes the rim 10, holes, which are penetrated by protruding portions of the first fastening portions 18, may be formed in the belt 24a installed to correspond to the inner circumferential edge of the rim 10.

Further, the belts 24a and 24b may have a mesh shape which is made of a metal material or a synthetic resin material having high tensile force and formed by connecting wires in the radial direction (width direction), and in the circumferential direction and the diagonal direction of the rim 10.

The tire cover 20 may be manufactured by a typical insert injection-molding method that forms the tire cover 20 by engaging the rim 10, in which the plurality of rings 12 is connected to one another by the binding members 16, with the belts 24a and 24b, which are disposed corresponding to the inner circumferential edge, or the outer circumferential edge, or both of the inner circumferential edge and the outer circumferential edge of the rim 10, mounting the rim 10 and the belts 24a and 24b into a mold, charging the mold with molten resin (synthetic rubber resin) so that spaces among the components are filled with the resin, and adhering the resin so that the resin integrally covers exteriors of the rim 10 and the belts 24a and 24b.

In a case in which the tire cover 20 is formed by the insert injection-molding method as described above, the interval support member 22 may be a part of the tire cover 20 which is formed as the space among the rings 12 that are spread at predetermined intervals is filled with the molten resin for manufacturing the tire cover 20.

In addition, when manufacturing the tire cover 20 by using the insert injection-molding method, the first fastening portions 18, which protrude inward from the rim 10, may be in a state of protruding toward an interior of the tire cover 20.

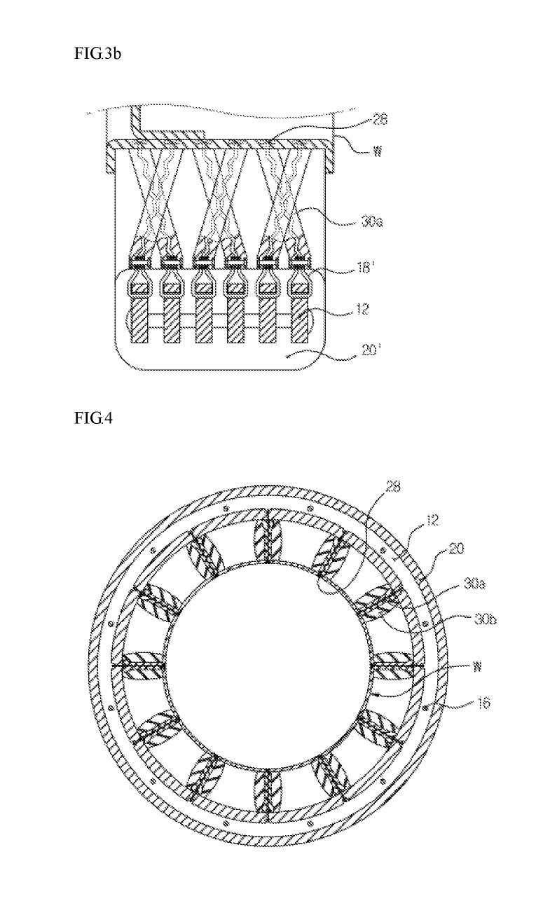

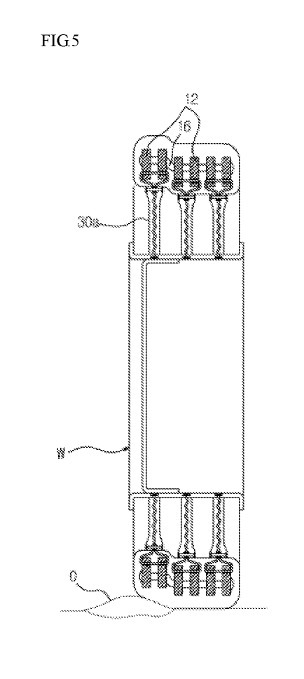

Meanwhile, as illustrated in FIGS. 3A to 5, second fastening portions 28, which correspond to the first fastening portions 18 in a one-to-one manner, are provided along a circumference of the tire wheel W which is disposed inside the tire cover 20 including the rim 10 so as to face the tire cover 20.

Further, the spokes 30a and 30b, which elastically support the tire cover 20 and the tire wheel W, are installed between the tire cover 20 and the tire wheel W, that is, between the first fastening portion 18 and the second fastening portion 28.

The spokes 30a and 30b may include a first spoke 30a which is installed in an extended state between the first and second fastening portions 18 and 28 and provides elastic force in a direction in which the interval between the first and second fastening portions 18 and 28 is decreased, and a second spoke 30b which is installed in a state of being compressed or fitted into an interval between the first and second fastening portions 18 and 28 in a one-to-one manner and provides elastic force in a direction in which the interval between the first and second fastening portions 18 and 28 is constantly maintained or increased.

Here, one end of the first spoke 30a is fastened to correspond to the first fastening portion 18, and the other end of the first spoke 30a is fastened to correspond to the second fastening portion 28.

In this case, the first spoke 30a serves to provide sufficient tensile force between the first and second fastening portions 18 and 28, and to this end, the first spoke 30a may be fixed to the second fastening portion 28 in a state in which the other end of the first spoke 30a penetrates the tire wheel W and the first spoke 30a is sufficiently extended.

Furthermore, when extending the first spoke 30a, elastic force, which contracts the first spoke 30a, is measured and adjusted to be at a uniform level along the circumference of tire wheel W, and then the first spoke 30a may be fixed.

Further, the first spoke 30a may be formed to connect one or more first fastening portions 18 disposed in the width direction of the tire among the plurality of rings 12 that constitutes the rim 10.

In addition, as illustrated in FIG. 3B, based on a center direction, one first spoke 30a is disposed to be inclined toward one side or the other side, and another adjacent first spoke 30a is disposed to be inclined in the opposite direction, such that the neighboring first spokes 30a may be disposed to cross each other.

The reason why the first spokes 30a, which are adjacent to each other in the width direction, are disposed to cross each other is to minimize deformation of the first spokes 30a by using tensile force sufficient to withstand frictional force and inertial force occurring when the vehicle travels through a curved section while the vehicle travels.

Further, in a case in which the arrangement of the first spokes 30a is divided into three or more sections in the width direction of the tire, the first spokes 30a, which are installed in the sections at both sides in the width direction, may have lower tensile force than the first spokes 30a installed in the intermediate section.

The reason why the tensile force varies in the width direction of the tire as described above is to maintain an overall circular shape of the intermediate section in the width direction of the tire and the remaining lateral sections when any one side of the tire based on the center of the tire locally collides with the obstacle O as illustrated in FIG. 5, thereby mitigating physical force caused by the collision.

Meanwhile, the second spoke 30b may be formed between the first and second fastening portions 18 and 28 so as to have a block shape which is made of an elastic rubber material and has a through hole penetrated by the first spoke 30a.

Here, the through hole, which is formed in the second spoke 30b and penetrated by the first spoke 30a, serves to protect the first spoke 30a between the first and second fastening portions 18 and 28, and maintain a state in which the second spoke 30b is supported by the first spoke 30a and stably fixed at the corresponding position.

In addition, the second spoke 30b may be installed by having a size corresponding, in a one-to-one manner, to the interval between the first and second fastening portions 18 and 28, that is, between the tire wheel W and the tire cover 20 including the rim 10 or by being fitted into the interval in an interference-fit manner.

Meanwhile, the tire cover may include a cover body 20a which integrally binds the rim, the belts disposed at the inner circumferential edge and/or the outer circumferential edge of the rim, and the binding member, and a tread portion 20b which covers an outer circumferential edge of the cover body 20a, has a tread formed on an outer circumferential surface of the tread portion 20b, and has both edge portions in the radial direction which elastically surround and cover a part of an inner circumferential edge of the cover body 20a.

In the aforementioned configuration, the cover body 20a and the tread portion 20b may be configured to be connected to each other by force of the tread portion 20b which elastically surrounds the cover body 20a and a frictional relationship therebetween, and the reason is to enable the tread portion 20b to be separated and replaced when the tread portion 20b is abraded due to contact with a road surface of the road.

Further, the reason why the first and second fastening portions 18 and 28 and the first and second spokes 30a and 30b, which connect the first and second fastening portions 18 and 28, are configured to be fastened to each other is to enable a partial replacement for coping with a likelihood of non-uniform abrasion or damage.

1. A non-pneumatic tire comprising:
a tire wheel;
a rim which is made of a rigid material and concentrically disposed at an interval with respect to the tire wheel;
spokes each of which has one side fastened to a circumference of the tire wheel and the other side fastened to a circumference of the rim and elastically supports the interval between the tire wheel and the rim; and
a tire cover which is coupled to cover the rim and has a tread pattern formed on an outer surface of the tire cover,
wherein the rim has a plurality of circular rings having a width and a thickness, the plurality of rings is disposed to face one another at intervals in a width direction of the tire cover, and interval support members, which elastically support the intervals among the rings and bind the rings, are provided among the rings.

2. The non-pneumatic tire of claim 1, further comprising:
belts which have tensile force in a radial direction, a circumferential direction, and a diagonal direction and are formed at an inner circumferential edge and/or an outer circumferential edge of the rim to cover a circumference of the rim.

3. The non-pneumatic tire of claim 2, wherein each of the rings has fastening holes which penetrate a surface of the ring in a thickness direction of the ring, and the rings are connected by binding members which are made of an elastic material and fastened to the fastening holes by penetrating the fastening holes from the arrangement of the rings.

4. The non-pneumatic tire of claim 2, wherein the tire cover is formed by connecting the rim, the belts disposed at the inner circumferential edge and/or the outer circumferential edge of the rim, and the binding members, mounting the rim, the belts, and the binding members into a mold, charging the mold with molten resin so that spaces among the components are filled with the molten resin, and integrally covering exteriors of the components, and the interval support member is a part of the tire cover with which the space among the rings is filled during a process of forming the tire cover.

5. The non-pneumatic tire of claim 4, wherein the ring has a plurality of first fastening portions which protrude from an inner side of the tire cover along an inner circumferential edge of the ring, the tire wheel has second fastening portions which correspond to the first fastening portions along a circumference of the tire wheel, and the spoke is installed between the first and second fastening portions.

6. The non-pneumatic tire of claim 5, wherein the spoke includes a first spoke which is installed in an extended state between the first and second fastening portions and provides elastic force in a direction in which the interval between the first and second fastening portions is decreased, and a second spoke which is installed in a compressed state between the first and second fastening portions and provides elastic force in a direction in which the interval between the first and second fastening portions is increased.

7. The non-pneumatic tire of claim 6, wherein the second spoke has a block shape which is made of an elastic rubber material and has a through hole corresponding to the interval between the first and second fastening portions, and is installed by having a size corresponding, in a one-to-one manner, to the interval between the first and second fastening portions or by being fitted into the interval in an interference-fit manner, and the first spoke has a band shape, and has one end that is connected to the first fastening portion, and the other end that penetrates the through hole and the wheel corresponding to the through hole so as to be connected to the second fastening portion inside the wheel.

8. The non-pneumatic tire of claim 4, wherein the tire cover includes a cover body which integrally binds the rim, the belts disposed at the inner circumferential edge and/or the outer circumferential edge of the rim, and the binding member, and a tread portion which covers an outer circumferential edge of the cover body, has both edge portions in a radial direction which elastically cover a part of an inner circumferential edge of the cover body, has mounting holes which are formed at both circumferential edges so as to be fitted with the first fastening portions, and has a tread formed on an outer circumferential surface of the tread portion.

9. The non-pneumatic tire of claim 4, wherein the spoke, which is installed at an intermediate portion in a width direction of the rim, has higher elastic force than the spokes installed at both sides in the width direction of the rim.

10. The non-pneumatic tire of claim 3, wherein the tire cover is formed by connecting the rim, the belts disposed at the inner circumferential edge and/or the outer circumferential edge of the rim, and the binding members, mounting the rim, the belts, and the binding members into a mold, charging the mold with molten resin so that spaces among the components are filled with the molten resin, and integrally covering exteriors of the components, and the interval support member is a part of the tire cover with which the space among the rings is filled during a process of forming the tire cover.

11. The non-pneumatic tire of claim 10, wherein the ring has a plurality of first fastening portions which protrude from an inner side of the tire cover along an inner circumferential edge of the ring, the tire wheel has second fastening portions which correspond to the first fastening portions along a circumference of the tire wheel, and the spoke is installed between the first and second fastening portions.

12. The non-pneumatic tire of claim 11, wherein the spoke includes a first spoke which is installed in an extended state between the first and second fastening portions and provides elastic force in a direction in which the interval between the first and second fastening portions is decreased, and a second spoke which is installed in a compressed state between the first and second fastening portions and provides elastic force in a direction in which the interval between the first and second fastening portions is increased.

13. The non-pneumatic tire of claim 12, wherein the second spoke has a block shape which is made of an elastic rubber material and has a through hole corresponding to the interval between the first and second fastening portions, and is installed by having a size corresponding, in a one-to-one manner, to the interval between the first and second fastening portions or by being fitted into the interval in an interference-fit manner, and the first spoke has a band shape, and has one end that is connected to the first fastening portion, and the other end that penetrates the through hole and the wheel corresponding to the through hole so as to be connected to the second fastening portion inside the wheel.

14. The non-pneumatic tire of claim 10, wherein the tire cover includes a cover body which integrally binds the rim, the belts disposed at the inner circumferential edge and/or the outer circumferential edge of the rim, and the binding member, and a tread portion which covers an outer circumferential edge of the cover body, has both edge portions in a radial direction which elastically cover a part of an inner circumferential edge of the cover body, has mounting holes which are formed at both circumferential edges so as to be fitted with the first fastening portions, and has a tread formed on an outer circumferential surface of the tread portion.

15. The non-pneumatic tire of claim 10, wherein the spoke, which is installed at an intermediate portion in a width direction of the rim, has higher elastic force than the spokes installed at both sides in the width direction of the rim.
